(19) United States
(12) Patent Application Publication
(10) Pub. No.: US 2025/0313668 A1
(43) Pub. Date: Oct. 9, 2025

(54) IONOMERS WITH IONIC BIS(SULFONYL)IMIDE MOIETY AND MEMBRANES CONTAINING THE SAME

(71) Applicant: Alliance for Sustainable Energy, LLC, Golden, CO (US)

(72) Inventors: Mou PAUL, Golden, CO (US); Bryan Scott PIVOVAR, Arvada, CO (US); Zbyslaw Roman OWCZARCZYK, Littleton, CO (US)

(21) Appl. No.: 19/171,837

(22) Filed: Apr. 7, 2025

Related U.S. Application Data
(60) Provisional application No. 63/575,019, filed on Apr. 5, 2024.

(51) Int. Cl. C08G 75/30; H01M 8/103

(52) U.S. Cl. CPC C08G 75/30; H01M 8/103

(57) ABSTRACT

This disclosure provides ionomers comprising a polymeric backbone that includes highly acidic bis(sulfonyl)imide groups and methods of making these ionomers and membranes formed from these ionomers and devices comprising these ionomer membranes.

### CROSS-REFERENCE TO RELATED APPLICATION

This application claims the benefit of U.S. Provisional Patent Application No. 63/575,019, filed on Apr. 5, 2024, the disclosure of which is incorporated by reference in its entirety herein.

### CONTRACTUAL ORIGIN

This invention was made with United States government support under Contract No. DE-AC36-08GO28308 awarded by the U.S. Department of Energy. The United States government has certain rights in this invention.

### FIELD

This disclosure relates to polymeric materials that may be useful as ionomers or polymer electrolyte membranes (PEM).

### BACKGROUND

A large body of scientific work and industrial research and development has been devoted in the last decades to the synthesis of proton-exchange membranes (PEMs) as an indispensable part of membrane electrode assemblies (MEAs), especially since the invention of Nafion™ in the late 1960's. Electrochemical energy conversion and storage devices where PEMs are used include polymer electrolyte fuel cells (PEFCs), direct alcohol fuel cells (DAFCs), regenerative fuel cells (RFCs), polymer electrolyte membrane water electrolyzers (PEMWEs) and redox flow batteries (RFBs).

The proton exchange membrane in fuel cells, electrolyzers, flow batteries, and other devices often use a perfluoro sulfonic acid (PFSA) ionomer as a sold electrolyte membrane or ion conducting binder in the electrodes. These side-chain acid polymers have exceptional ion conductivity and chemical stability, but the total acid content, and therefore the ion conductivity, is limited by the copolymer ratio between the tetrafluoroethylene (TFE) and the functionalized vinyl ether monomer. Typically, the lower copolymer ratio attainable is on the order of approximately 2 or 3 TFE units per vinyl ether unit. Thus, there remains a need for an alternative to PFSAs for PEMs in fuel cells and electrolyzers.

Many of the requirements for effectiveness are the same and have long been recognized. However, it is only recently that notable advancements have been made to enable chemically and mechanically stable membranes with high proton conductivity. An extensive library of polymers and ionomers has been developed and evaluated in recent years.

To decrease PEM resistivity to increase the output power of the fuel cells, thinner membranes with a polymer reinforcement have been formulated. Gas permeability inevitably increases by thinning the membrane, and the improvement of the proton conductivity of these thin membranes is highly desirable. Perfluorosulfonic acid (PFSA) ionomer membranes, such as Nafion™ have been used as the proton exchange membranes in commercial PEMFCs. The perfluorinated structure of PFSAs induces microphase separation between hydrophobic backbones and hydrophilic acid sites on side-chain terminals and yields high proton conductivity. The equivalent weight (EW) of PFSAs is inversely proportional to their ion-exchange capacity, and lowering the EW is the most straightforward way to increase proton conductivity. The best way to do so is to increase the ratio of the side-chain comonomer, but this results in membranes that are physically unstable due to significant water uptake and swelling at a high relative humidity. The introduction of polymer side chains shorter than that of Nafion™ is another way to lower the EW, and PFSAs with shorter side chains have also been commercialized, but their EW is still greater than 700.

The introduction of different types of acid sites on the polymer side chains has also been examined. For example, bis(perfluoroalkylsulfonyl)imides have been shown to be very strong acids, and they are stronger than perfluorosulfonic acids. Pefluorobis(sulfonyl)imide (PFSI) ionomer membranes have been developed using the same precursor sulfonyl fluoride polymer as the PFSA ionomers, and these PFSI ionomers showed comparative performance to Nafion™. But most of these PFSI ionomers have a higher EW than the corresponding PFSA ionomers. The introduction of multiple acid sites on each side chain was expected to be more effective to lower EW without changing the comonomer ratio and affecting the mechanical properties of the polymer membranes. Researchers at 3M developed perfluorobis(sulfonyl)imide sulfonic acid (PFIA) ionomers that have bis(perfluoroalkylsulfonyl)imide and sulfonic acid functional groups on each side chain. This group also developed ionomers with two or more bis(sulfonyl)imides on each side chain and achieved an EW less than 500. The proton conductivity of these PFIA ionomer membranes is higher than that of the PFSA ionomer membranes at the same relative humidity and temperature, but they also show a larger voltage drop and larger high-frequency resistance than the PFSA ionomer membranes.

Therefore, a need still exists for highly acidic PEMs with high conductivity that are mechanically and chemically strong and durable with limited water uptake and swelling, and preferably with low-cost synthesis methods.

### SUMMARY

Due to their high chemical stability and conductivity, perfluorosulfonic acid polymers (PFSAs) have been the only active materials used in commercial proton exchange membranes (PEM) for electrochemical energy conversion devices, such as fuel cells, electrolyzers, and chlor-alkali. But the handling and polymerization of PFSA monomers (using, for example, tetrafluoroethylene, TFE) poses tremendous safety issues and hence only a handful of industrial manufactures are willing to produce them at commercial scale. The monomers used to produce PFSAs are limited to free-radical polymerization routes resulting in limited synthesis options, and there are growing environmental concern about PFSA connections to “forever” chemicals (leading some industries to question their role in this area going forward. These considerations have the potential to threaten the fuel cell and electrolysis industries unless alternatives are found that alleviate these issues.

The present inventors have identified a series of monomers that maintain the advantages of PFSAs (high acidity necessary for conductivity, and chemical stability) while alleviating concerns of forever chemicals. These monomers may be polymerized to form ionomers through condensation chemistry overcoming many of the key shortcomings of PFSA polymers, including high cost and poor mechanical stability at high temperature.

The ionomers provided in this disclosure are based on a highly acidic sulfonyl imide (SO₂—NH—SO₂) group formed within the backbone of the polymer, as opposed to appearing within side chain or pendant groups linked along a perfluorinated alkyl backbone of prior art PFSA polymers. The monomeric units containing sulfonyl imide groups are copolymerized, for example through polycondensation reactions, with additional monomers to form novel ionomers with different combinations of monomers to balance physical characteristics of the resulting ionomers, such as conductivity, durability, acidity, solubility, water uptake and swelling, etc.

The ionomers of this disclosure containing highly acidic sulfonyl imide (SO₂—NH—SO₂) groups formed within the backbone of the polymer display exceptional conductivity, especially under hot and dry conditions.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates the synthesis strategy of multiblock ionomers containing hydrophilic bis(sulfonyl)imide acidic groups and biphenol polysulfone hydrophobic groups.

FIG. 2 illustrates the synthesis strategy of multiblock ionomers containing hydrophilic bis(sulfonyl)imide acidic groups and bisphenol A polysulfone hydrophobic groups.

FIG. 3 illustrates the synthesis strategy of multiblock ionomers containing hydrophilic bis(sulfonyl)imide acidic groups and deca-fluoro-biphenyl hydrophobic groups.

FIG. 4 is a graph comparing conductivity of the ionomers of this disclosure containing hydrophilic bis(sulfonyl)imide acidic groups and deca-fluoro-biphenyl hydrophobic groups compared with the conductivity of commercial product Nafion™ 212, at varying relative humidity.

### DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

As used herein, the term “equivalent weight” (or “EW”) of a polymer means the weight of polymer which will neutralize one equivalent of base (allowing that, where sulfonyl halide substituents or other substituents that would be converted into acidic functions during use of the polymer in a fuel cell are present, “equivalent weight” refers to the equivalent weight after hydrolyzation of such groups).

As used herein, the term “highly fluorinated” means containing fluorine in an amount of 40 wt % or more, typically 50 wt % or more and more typically 60 wt % or more.

As used herein, the term “substituted” means, for a chemical species, substituted by conventional substituents which do not interfere with the desired product or process, e.g., substituents can be alkyl, alkoxy, aryl, phenyl, halogen (F, Cl, Br, I), cyano, nitro, etc.

The terms “proton exchange membrane” or its abbreviation “PEM” refer to a composite membrane generally made from ionomers and designed to conduct protons. The terms “proton exchange membrane fuel cell” or “PEM fuel cell,” or its abbreviation “PEMFC,” refer to a fuel cell using the PEM.

As used herein, the term “ionomer” or “conducting polymer” generally refers to a polymer that conducts ions. More precisely, the ionomer refers to a polymer that includes repeat units of at least a fraction of ionized units.

As used herein, the term “polymer” encompasses homopolymers and copolymers. The polymers of this disclosure can be homopolymers, or they can be co-polymers of two or more respective monomers, which may vary as structural repeat units or which may vary as the same structural repeat unit with different substituents. The composition may comprise one or more different hydrophilic polymers and one or more different hydrophilic polymers. The monomer(s) from which the polymers may be formed are referred to as a “precursor monomer.” A copolymer will have more than one precursor monomer.

As used herein, the term “alkyl” refers to a group derived from an aliphatic hydrocarbon and includes linear, branched and cyclic groups which may be unsubstituted or substituted. The term “heteroalkyl” is intended to mean an alkyl group, wherein one or more of the carbon atoms within the alkyl group has been replaced by another atom, such as nitrogen, oxygen, sulfur, and the like. The term “alkylene” refers to an alkyl group having two points of attachment. The term “alkenyl” refers to a group derived from an aliphatic hydrocarbon having at least one carbon-carbon double bond, and includes linear, branched and cyclic groups which may be unsubstituted or substituted. The term “heteroalkenyl” is intended to mean an alkenyl group, wherein one or more of the carbon atoms within the alkenyl group has been replaced by another atom, such as nitrogen, oxygen, sulfur, and the like. The term “alkenylene” refers to an alkenyl group having two points of attachment.

As used herein, a “a bis(sulfonyl)imide” has the chemical formula: R—SO₂—NH—SO₂—R, where the “R” groups are the same or different at each occurrence and may be a single bond or an alkylene group, an alkylene group, a hydrogen or an alkyl group, an aryl group or substituted aryl, an amine or substituted amine. In particular, any of these chemical groups may have fluorine (F) substituted for one or more hydrogens, including perfluorinated groups.

The ionomers of this disclosure include a bis sulfonyl)imide-containing homopolymer or copolymer. The copolymer may include a polysulfone and/or a polyethersulfone, such as a fluorinated and partially sulfonated poly(arylene ether sulfone). The copolymer can be a block copolymer. Examples of comonomers include, but are not limited to polysulfones and/or a polyethersulfones, and substituted derivatives thereof and salts thereof.

The monomers making up the ionomers of this disclosure may be highly fluorinated or even perfluorinated and may include a plurality of side chains along the bis(sulfonyl)imide-containing polymer backbone. Ideally, the ionomer is fluorinated, however in some embodiments the ionomer is highly fluorinated comprising carbon-hydrogen bonds at the terminal ends of the polymer, where the polymerization reaction is initiated or terminated. The side chains along the ionomer backbone may comprise protogenic group(s) and at least one perfluorinated carbon. A protogenic group is a group which is able to donate a proton or hydrogen ion. Exemplary protogenic groups include: sulfonic acid, a bis(sulfonyl)imide, a sulfonamide, a sulfonyl methide, and salts thereof. If such side chains are present, they may comprise more than one protogenic group, and the protogenic groups may be the same or different.

Among other things, this disclosure provides a new class of polymer electrolytes based on highly acidic bis(sulfonyl)imide (—SO₂—NH—SO₂—) groups formed through condensation chemistry which may maintain the key advantages of perfluorosulfonic acid polymers (PFSAs), while opening up synthetic pathways that may address the key shortcomings of PFSAs which include high cost, mechanical instability, difficult production processing, environmental hazards, and high hydrogen crossover. The ionomers of this disclosure materials may enable increased power density operation at improved cell efficiency and improved durability. While many of the target polymers described herein contain fluorine, some embodiments may not include fluorine. Even the fluorine containing materials synthesized are likely to alleviate most of the “forever chemical” concerns of current PFSAs.

The ionomers of this disclosure may be formed through condensation polymerization of disulfonyl halide monomers with disulfonamide monomers in a condensation reaction resulting in highly acidic bis(sulfonyl)imide groups (—SO₂—NH—SO₂—) formed within the polymer backbone. Due to the ability of numerous chemical groups to serve as monomers within this architecture, there is significant flexibility in tuning acidity and spacing of the resulting condensation polymers (or oligomers). Perfluoroalkyl monomers offer the greatest opportunity for high acidity and acid density due to strong electron withdrawing and short segment lengths achievable (down to a single methylene unit).

An exemplary perfluoro C3(propyl)/C4(butyl) version of an ionomer of this disclosure comprising the highly acidic bis(sulfonyl)imide groups (—SO₂—NH—SO₂—) formed within the polymer backbone polymer has been formulated and tested and found to have approximately one order of magnitude improvement in conductivity over traditional PFSAs under substantially equivalent conditions. This material represents one of, if not the highest proton conductivity polymer synthesized to date due to its very high ion exchange capacity (IEC) over 3 meq/g. This may result in limited mechanical properties as the polymer dissolves/loses mechanical integrity in water at moderate (below approximately 75%) relative humidity (RH). This high conductivity value in a chemistry that is expected to exhibit exceptional chemical stability and low catalyst-ionomer interactions offers numerous pathways to trade off some conductivity for mechanical robustness.

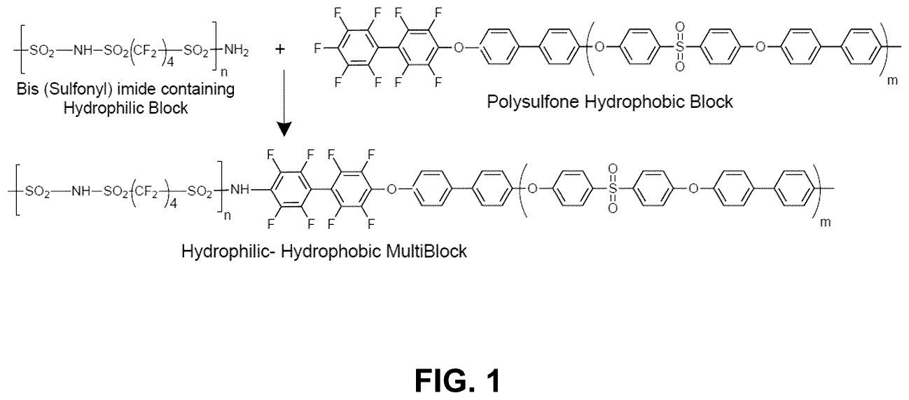

In order to pursue the decoupling of mechanical and active (conducting) polymer domains within the ionomers of this disclosure, these polymers may be formed as multi-block copolymers using various synthesis routes such as polycondensation (in which two functional groups react and eliminate a small molecule) (as illustrated in FIGS. 1, 2, and 3). Using the multi-block polymer formation approach, three batches of multiblock copolymers with slightly differing block lengths were initially formed and tested. Early tests had poor film-forming properties, perhaps due to short block lengths, the specific volume fractions of each phase, synthesis challenges, and/or limited casting exploration. Another test (experimental IEC of approximately −0.96 meq/g) based on the coupling of the bis(sulfonyl)imide containing hydrophilic oligomer (MW of approximately 4350 g/mole) and a polyarylene ether sulfone based hydrophobic oligomer (MW of approximately 3600 g/mole) formed useful polymeric films and showed promising conductivity and water uptake characteristics when cast from an approximately 8% DMAc solution. Water uptake was also significantly decreased, showing only a slightly higher uptake than traditional PFSAs (such as Nafion™ 212) at a given relative humidity.

The ionomers of this disclosure may include further advances to tune the mechanical and active polymer segments as well as the resultant multiblock structure and properties. The synthesis strategy may include a process where different combinations of monomers can give rise to random copolymers or oligomer segments. For multiblocks, the molecular weight and the end group functionality of various hydrophilic and hydrophobic oligomers may be varied by manipulating the reaction time and the stoichiometry of the reacting monomers. The impact of the lengths of specific oligomer segments and casting conditions on properties may be systematically probed. A limited number of controlled length segments of the hydrophilic and hydrophobic oligomers and corresponding multiblocks (as shown in FIGS. 1, 2, and 3) have been tested. These materials may be characterized as polymers, cast in membranes, and characterized by key physical membrane properties, and may also be dispersed into solvents for exploration as ionomer solutions. Physical property characterization may include water uptake, IEC measurements, conductivity, mechanical properties, and/or hydrogen permeability. Structural characterization may investigate domain sizes, composition, connectivity through microscopy (SEM, TEM, and/or AFM) and scattering (x-ray/neutron) studies. These may lead to improved structure-property understanding and may enable the achievement of desired properties.

The ionomers of this disclosure and the methods of making these ionomers may have many improvements over traditional sidechain PFSA ionomers. Some of these improvements may include maximizing the number of charge carriers present in the polymer structure. Traditional PFSAs typically comprise a non-conductive backbone and side chain mass that limits the ion-exchange capacity (IEC) (mmol/g) or the equivalent weight (EW) (g/mol). Another improvement may be ionomers disclosed herein that are synthesized through condensation or step-polymerizations that do not require handling tetrafluoroethylene. This may result in safer polymerizations and variations to the polymer architecture that may be difficult for TFE-containing ionomers. Another improvement may be that the chemically weak backbone/side chain linking groups present in PFSA ionomers, which typically contain a tertiary fluorine or an ether group, may be eliminated within the ionomers of this disclosure, allowing for a potentially more stable ionomer. Also, the ionomers of this disclosure may be formed at a lower cost than traditional PFSAs, which often have expensive monomer and polymer synthesis steps. These advantages may be present when the ionomers of the present disclosure are substantially water insoluble and/or are held substantially immobile on a solid surface.

Thus, in one aspect, this disclosure provides bis (sulfonyl) imide-containing ionomers. These ionomers comprise a polymer backbone having the chemical formula:

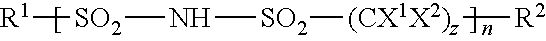

Within this chemical formula, R¹ includes at least one chemical group selected from the group consisting of SO₂NH₂; sulfonic acid; alkyl optionally substituted with F, Cl, Br, and I; aryl optionally substituted with F, Cl, Br, and I; amine optionally substituted with F, Cl, Br, I, and alkyl; polysulfone; polyethersulfone; and salts of these chemical groups; and combinations of these chemical groups.

Within this chemical formula, R² comprises at least one chemical group selected from the group consisting of phenyl optionally substituted with F, Cl, Br, and I; alkyl optionally substituted with F, Cl, Br, and I; ether; polysulfone; polyethersulfone; and salts of these chemical groups; and combinations of these chemical groups.

Within this chemical formula, X¹ and X² are independently selected from H, F, Cl, Br, and I; z is 1-20 (i.e., an integer between and including 1 and 20) and n is 2-100 (i.e., an integer between and including 1 and 20).

In the ionomers of this disclosure, R¹ within this chemical formula may comprise SO₂NH₂ or sulfonic acid. Alternatively, or additionally, R¹ within this chemical formula may comprise the chemical formula:

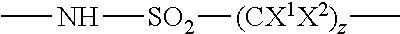

wherein X¹ and X² are independently selected from H, F, Cl, Br, and I; and, z is 1-20.

Alternatively, or additionally, in the ionomers of this disclosure, R¹ within this chemical formula may comprise phenyl optionally substituted with F, Cl, Br, and I.

In exemplary ionomers of this disclosure, R¹ within the chemical formula set forth above that defines the polymer backbone may comprise a repeating unit having the chemical formula:

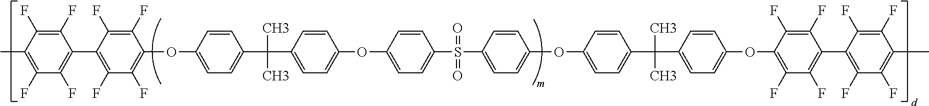

Within this chemical formula, m and d are independently 2-150 (i.e., an integer between and including 2 and 150).

In other exemplary ionomers of this disclosure, R¹ within the chemical formula set forth above that defines the polymer backbone may comprise a repeating unit having the chemical formula:

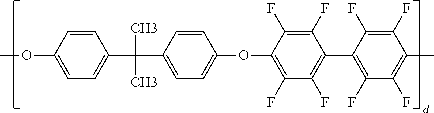

Similarly, within this chemical formula, d is 2-150.

In the ionomers of this disclosure, R² within the chemical formula set forth above that defines the polymer backbone may comprise one of:

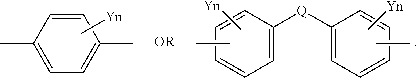

In these chemical formulas, Y may be SO₃H, CF₂SO₃H, PO₃H, or N⁺R where R may be alkyl or aryl; n is 1-4 (i.e., an integer between and including 1 and 4), and Q may be O, CO, SO₂, C—(CH₃)₂, or P(O)R wherein R is alkyl, or C (CX¹X²)_{z}, wherein X¹ and X² are independently selected from H, F, Cl, Br, and I; and z is 1-20.

Alternatively, or additionally, R² within this chemical formula may be —NH₂, or —SO₂NH₂, or —SO₃H.

Alternatively, or additionally, R² within this chemical formula may be phenyl optionally substituted with any one or more of F, Cl, Br, and I.

Alternatively or additionally, R² within this chemical formula may be (CX¹X²) z or (CX¹X²)_{z}NH, wherein X¹ and X² are independently selected from H, F, Cl, Br, and I; and z is 1-20.

In other exemplary ionomers of this disclosure, R² within the chemical formula set forth above that defines the polymer backbone may comprise a repeating unit having a chemical formula selected from the group consisting of:

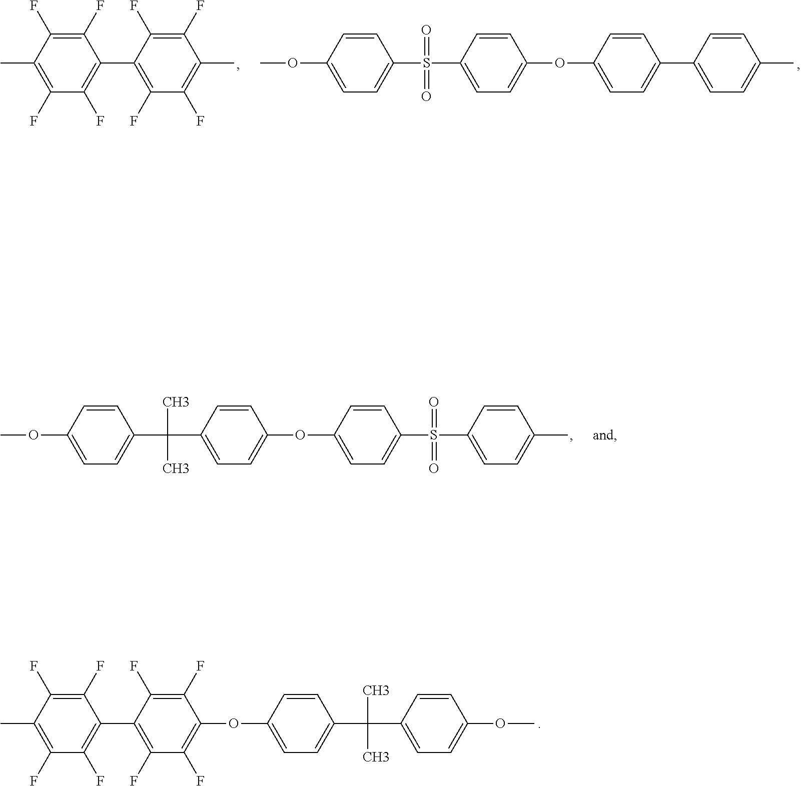

In other exemplary ionomers of this disclosure, the chemical formula set forth above that defines the polymer backbone may comprise a repeating unit having the chemical formula:

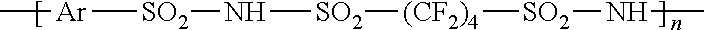

In this chemical formula, n is 2-100 (i.e., n is an integer between and including 2 and 100).

In this chemical formula, Ar may be one of:

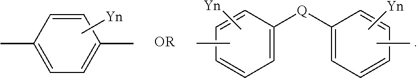

In these chemical formulas, Y may be SO₃H, CF₂SO₃H, PO₃H, or N⁺R where R may be alkyl or aryl; n is 1-4 (i.e., an integer between and including 1 and 4), and Q may be O, CO, SO₂, C—(CH₃)₂, or P(O)R wherein R is alkyl, or C(CX¹X²)_{z}, wherein X¹ and X² are independently selected from H, F, Cl, Br, and I; and z is 1-20.

In other exemplary ionomers of this disclosure, the chemical formula set forth above that defines the polymer backbone may comprise a repeating unit having the chemical formula:

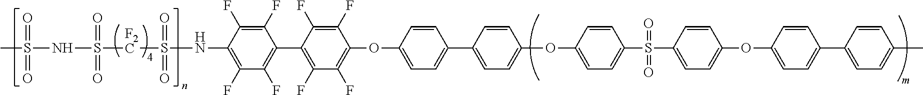

In this chemical formula, n is 2-100 and m is 2-150.

In other exemplary ionomers of this disclosure, the chemical formula set forth above that defines the polymer backbone may comprise a repeating unit having the chemical formula:

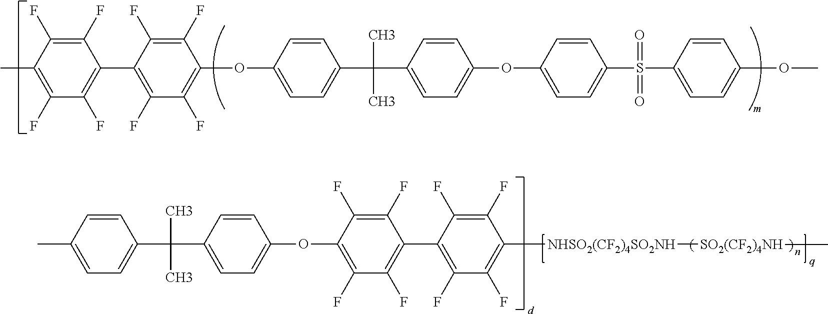

In this chemical formula, n is 2-100; m is 2-150; d is 2-150; and q is 2-150.

In other exemplary ionomers of this disclosure, the chemical formula set forth above that defines the polymer backbone may comprise a repeating unit having the chemical formula:

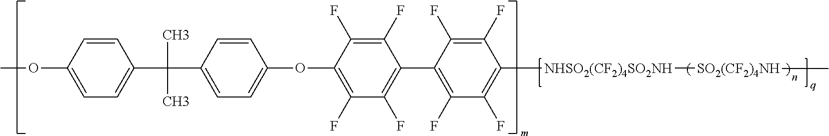

In this chemical formula, m is 2-150; n is 2-100; and q is 2-150.

Another exemplary ionomer of this disclosure is a bis(sulfonyl)imide ionomer comprising a polymer backbone having the chemical formula:

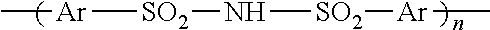

In this chemical formula, n is 2-100 and Ar is independently:

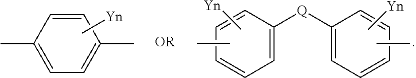

In these chemical formulas, Y may be SO₃H, CF₂SO₃H, PO₃H, or N⁺R where R may be alkyl or aryl; n is 1-4 (i.e., an integer between and including 1 and 4), and Q may be O, CO, SO₂, C—(CH₃)₂, or P(O)R wherein R is alkyl, or C(CX¹X²) z, wherein X¹ and X² are independently selected from H, F, Cl, Br, and I; and z is 1-20.

The ionomers of this disclosure may be useful for making a polymer electrolyte membrane (PEM). The ionomer may be formed into a polymer electrolyte membrane by any suitable method, including casting, molding, and extrusion. Typically, the membrane is cast from a polymer dispersion (e.g., any of the ionomers described herein in any of their embodiments) and then dried, or annealed, or both. The ionomer may be cast from a suspension. Any suitable casting method may be used, including bar coating, spray coating, slit coating, and brush coating. After forming, the membrane may be annealed, typically at a temperature of 120° C. or higher, more typically 130° C. or higher, most typically 150° C. or higher. For example, a PEM may be obtained by forming an bis(sulfonyl)imide-containing ionomer of this disclosure in a polymer dispersion, optionally purifying the dispersion by ion-exchange purification, and concentrating the dispersion to make a membrane. Typically, if the bis(sulfonyl)imide-containing copolymer dispersion is to be used to form a membrane, the concentration of copolymer is advantageously high (e.g., at least 20, 30, or 40 percent by weight). Often a water-miscible organic solvent is added to facilitate film formation. Examples of useful water-miscible solvents include lower alcohols (e.g., methanol, ethanol, isopropanol, n-propanol), polyols (e.g., ethylene glycol, propylene glycol, glycerol), ethers (e.g., tetrahydrofuran and dioxane), ether acetates, acetonitrile, acetone, dimethylsulfoxide (DMSO), N,N dimethylacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof.

To enhance the mechanical stability or durability of membranes formed from the ionomers of this disclosure, the ionomers may be loaded into a porous supporting matrix, typically in the form of a thin membrane having a thickness of up to 90 micrometers, up to 60 micrometers, or up to 30 micrometers. Any suitable method of loading an ionomer of this disclosure into the pores of a supporting matrix may be used, including overpressure, vacuum, wicking, and immersion. Any suitable supporting matrix may be used. Typically, the supporting matrix is electrically non-conductive. The supporting matrix may be composed of a fluoropolymer, which may be perfluorinated. Typical supporting matrices include porous polytetrafluoroethylene (PTFE), such as biaxially stretched PTFE webs. In another embodiment fillers (e.g., fibers) might be added to an ionomer of this disclosure to reinforce the membrane formed from an ionomer of this disclosure.

Additionally or alternatively, the mechanical stability or durability of membranes formed from the ionomers of this disclosure may be enhanced by combining the ionomers with polymer nanofibers. These polymer nanofibers may also comprise a proton conducting polymer.

The scope of this disclosure should not be restricted solely to polymer electrolyte membranes, or electrolyzer or fuel cell applications, as one can envision applications outside of these uses and devices.

Objects and advantages of this disclosure are further illustrated by the following examples, but the particular materials and amounts thereof recited in these examples, as well as other conditions and details, should not be construed to unduly limit this disclosure.

### EXAMPLES

Without intent to limit the scope of the invention, examples and their related results according to embodiments of the present invention are given below. Note that titles or subtitles may be used in the examples for convenience of a reader, which in no way should limit the scope of the invention. Unless otherwise noted or readily apparent from the context, all parts, percentages, ratios, etc. in the Examples and the rest of the disclosure are by weight.

### Example 1: Preparation and Testing of a Hydrophilic-Hydrophobic Multiblock Polymer Containing Bis(sulfonyl)imide Acidic Groups

This example illustrates the preparation of an ionomer of this disclosure that contains bis(sulfonyl)imide acidic groups. A multiblock ionomer was created by reacting a hydrophilic block containing bis(sulfonyl)imide acidic groups and a hydrophilic block containing biphenol polysulfone units. FIG. 1 shows the synthesis scheme for this hydrophilic-hydrophobic multiblock where the hydrophilic block is a bis(sulfonyl)imide-based block polymer (wherein n is 2-100) and the hydrophobic block is a biphenol-based polysulfone block (wherein m is 1-30).

We have prepared several multiblocks with varying block lengths of the “functional block,” which is the bis(sulfonyl)imide-containing hydrophilic block and the “mechanical block” which is the polysulfone hydrophobic block as depicted in FIG. 1. The block lengths (i.e., the number of repeat units, n for the functional block, and m, for the mechanical block), have been varied and the molecular weight of the individual blocks (Kg/mole) are shown in Table 1.

The experimental Ion exchange capacity (Expt. IEC, in mmol/gram polymer) was measured by the acid-base titration method. The trend generally observed for PEMs is an increase in proton conductivity with increasing IEC and as shown in Table 1, the largest IEC was observed in the multiblock polymer containing equal molecular weight of each of the individual (functional and mechanical) polymer blocks.

Water uptake was measured as liquid water uptake at room temperature and as water uptake at 95% relative humidity at 60° C. The trend generally observed for PEMs is an increase in proton conductivity with increasing concentration of acid groups and water content, water being necessary to ensure proton mobility. As shown in Table 1, the water uptake increases with increasing IEC, (i.e., the concentration of ionic groups).

Conductivity (mS/cm) was measured at 95% relative humidity and 60° C. and is shown for two variations of the multiblock ionomer listed in Table 1. As expected, greater water uptake correlated with greater conductivity.

These data demonstrate that an increase in the proportion of the “functional block” (the bis(sulfonyl)imide-containing hydrophilic block) in these multiblock ionomers results in a greater water uptake and greater conductivity.

TABLE 1
Experimental observations for a multiblock polymer formed with
bis(sulfonyl)imide acidic units and biphenol polysulfone units.

| | | | | Liquid | | |
|---|---|---|---|---|---|---|
| | Functional | Mechanical | Expt | Water | 95% RH | Conductivity |
| Multiblock | block | block | IEC | uptake | 60 C. water | (95% RH, 60 C.) |
| copolymer | (Kg/mol) | (Kg/mol) | (mmol/g) | (RT) | uptake | (mS/cm) |
| 1 | 3.5 | 3 | 0.69 | | | |
| 2 | 3.5 | 4.5 | 0.84 | 47% | | |
| 3 | 3.6 | 3.6 | 1.2 | 31% | 6% | 56 |
| 4 | 3.8 | 3.6 | 0.29 | | 3% | |
| 5 | 4.1 | 3.6 | 0.94 | 79% | 21% | 91 |
| 6 | 4.1 | 5 | 0.17 | 89% | 4% | |

### Example 2: Preparation and Testing of a Multiblock Polymer Containing Bis(sulfonyl)imide and Polysulfone Repeating Units

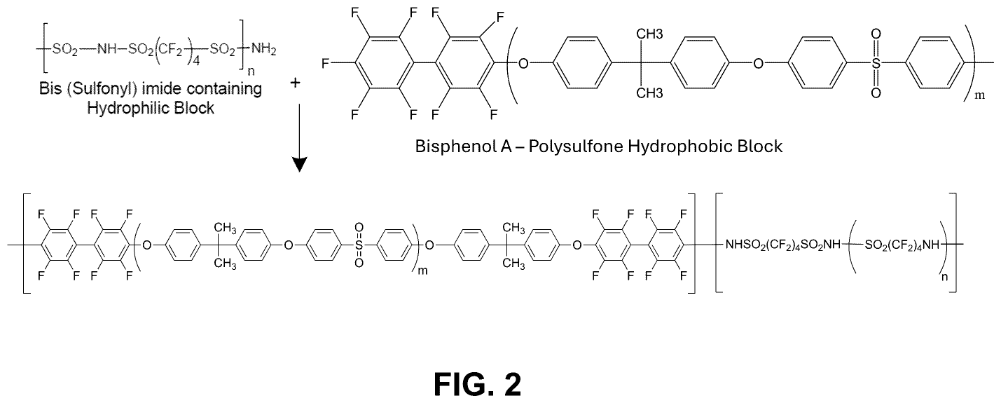

This example illustrates the preparation of another ionomer of this disclosure that contains bis(sulfonyl)imide and bisphenol A-based polysulfone repeating units. A multiblock ionomer was created by reacting the same hydrophilic block containing bis (sulfonyl) imide acidic groups used in Example 1, supra, and another hydrophilic block containing the polysulfone units shown in the synthesis scheme of FIG. 2, wherein the hydrophilic block is the bis (sulfonyl) imide-based block polymer (wherein n is 2-100) and the hydrophobic block is a bisphenol A-based polysulfone block (wherein m is 2-150), as opposed to the biphenol polysulfone repeating unit used to produce the ionomer described and tested in Example 1.

We have prepared several multiblocks with varying block lengths of the “functional block,” which is the bis(sulfonyl)imide-containing hydrophilic block and the “mechanical block” which is the bisphenol A-polysulfone hydrophobic block as depicted in FIG. 2. The block lengths (i.e., the number of repeat units, n for the functional block, and m, for the mechanical block), have been varied and the molecular weight of the individual blocks (Kg/mole) are shown in Table 2.

TABLE 2
Experimental observations for a multiblock polymer formed with bis(sulfonyl)imide
acidic units and bisphenol A polysulfone units.

| | Functional | Mechanical | Theoretical | Expt | | 95% RH |
|---|---|---|---|---|---|---|
| Multiblock | block | block | IEC | IEC | Liquid Water | 60 C. water |
| copolymer | (Kg/mole) | (Kg/mole) | (mmol/g) | (mmol/g) | uptake (RT) | uptake |
| 1 | 5.86k | 5.65k | 1.48 | 0.663 | 42% | 14% |
| 2 | 8.55k | 5.65k | 1.76 | 0.668 | n/a | 9% |

### Example 3: Preparation and Testing of a Multiblock Polymer Containing Bis(sulfonyl)imide and Decafluorobiphenyl Repeating Units

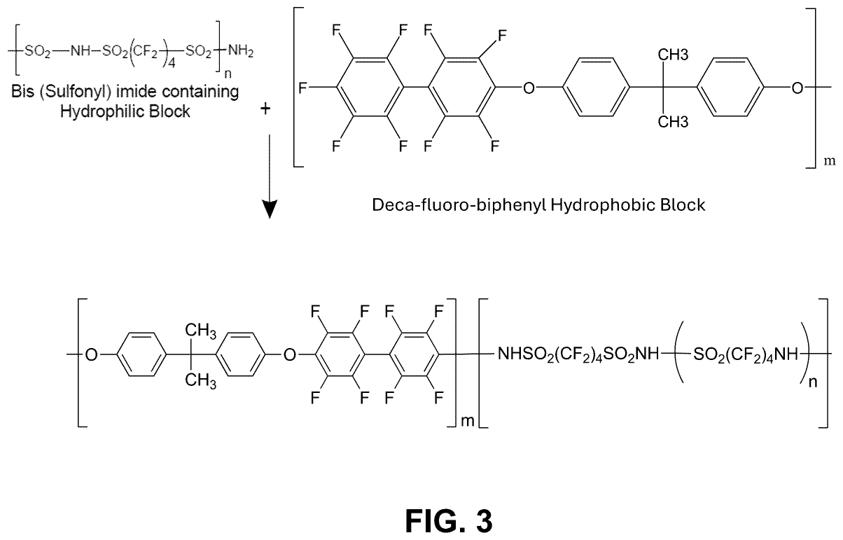

This example illustrates the preparation of another ionomer of this disclosure that contains bis(sulfonyl)imide and bisphenol A-based polysulfone repeating units. A multiblock ionomer was created by reacting the same hydrophilic block containing bis(sulfonyl)imide acidic groups used in Examples 1 and 2, supra, and another hydrophilic block containing 1,2,3,4,5-Pentafluoro-6-(2,3,4,5,6-pentafluorophenyl)benzene (“decafluorobiphenyl”) units shown in the synthesis scheme of FIG. 3, wherein the hydrophilic block is the bis (sulfonyl) imide-based block polymer (wherein n is 2-100) and the hydrophobic block is a decafluorobiphenyl-based block (wherein m is 2-150).

We have prepared several multiblocks with varying block lengths of the “functional block,” which is the bis(sulfonyl)imide-containing hydrophilic block and the “mechanical block” which is the decafluorobiphenyl-based hydrophobic block as depicted in FIG. 3. The block lengths (i.e., the number of repeat units, n for the functional block, and m, for the mechanical block), have been varied and the molecular weight of the individual blocks (Kg/mole) are shown in Table 3.

TABLE 3
Experimental observations for a multiblock polymer formed with bis(sulfonyl)imide
acidic units and decafluorobiphenyl-based units.

| | Functional | Mechanical | Theoretical | Expt | | 95% RH |
|---|---|---|---|---|---|---|
| Multiblock | block | block | IEC | IEC | Liquid Water | 60 C. water |
| copolymer | (Kg/mole) | (Kg/mole) | (mmol/g) | (mmol/g) | uptake (RT) | uptake |
| 1 | 5.83k | 5.0k | 1.57 | 0.875 | 42% | 16% |
| 2 | 8.55k | 5.0k | 1.84 | 0.9 | 41% | 13% |
| 3 | 5.10k | 3.0k | 1.82 | 0.93 | 37% | 23% |
| 4 | 5.86k | 3.0k | 1.96 | 0.907 | n/a | 14% |

The experimental ion exchange capacity (Expt. IEC, in mmol/gram polymer) was again measured by the acid-base titration method and is shown in Table 3. Water uptake was measured as liquid water uptake at room temperature and as water uptake at 95% relative humidity at 60° C.

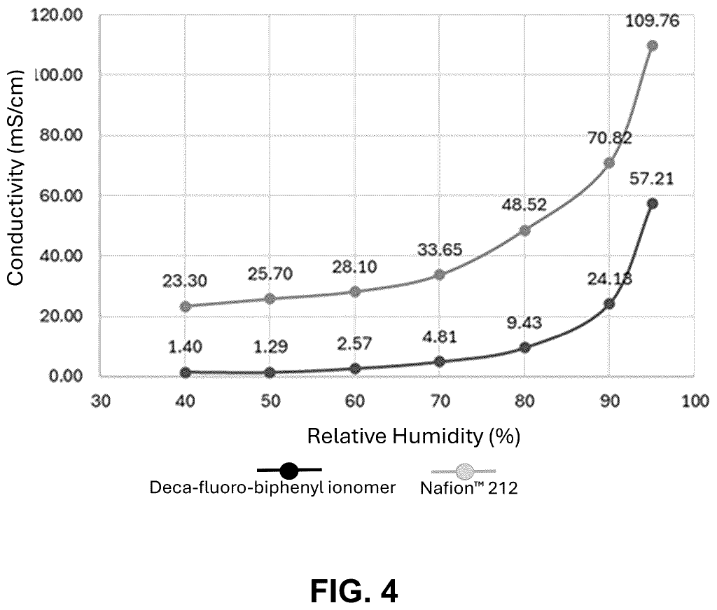

The conductivity (in mS/cm)) of this bis(sulfonyl)imide and deca-fluoro-biphenyl containing ionomer was tested and compared to the conductivity of the Nafion™ 212 (perfluorosulfonic acid (PFSA)) ionomer at 60° C. and relative humidity varying between 40% and 95% relative humidity. The comparative results are shown in FIG. 4.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A bis(sulfonyl)imide ionomer comprising a polymer backbone having the chemical formula: 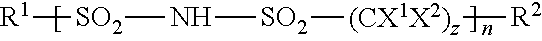
wherein:
R¹ comprises at least one chemical group selected from the group consisting of:
SO₂NH₂;
sulfonic acid;
alkyl optionally substituted with F, Cl, Br, and I;
aryl optionally substituted with F, Cl, Br, and I;
amine optionally substituted with F, Cl, Br, I, and alkyl;
polysulfone;
polyethersulfone;
and salts thereof;
and combinations thereof; and,
R² comprises at least one chemical group selected from the group consisting of:
phenyl optionally substituted with F, Cl, Br, and I;
alkyl optionally substituted with F, Cl, Br, and I;
ether;
polysulfone;
polyethersulfone;
and salts thereof;
and combinations thereof; and,
X¹ and X² are independently selected from H, F, Cl, Br, and I;
z is 1-20 and,
n is 2-100.

2. The ionomer of claim 1, wherein R¹ comprises SO₂NH₂ or sulfonic acid.

3. The ionomer of claim 1, wherein R¹ comprises phenyl optionally substituted with F, Cl, Br, and I.

4. The ionomer of claim 1, wherein:
R¹ comprises —NH—SO₂—(CX¹X²)z-, and
X¹ and X² are independently selected from H, F, Cl, Br, and I; and,
z is 1-20.

5. The ionomer of claim 1, wherein:
R¹ comprises, 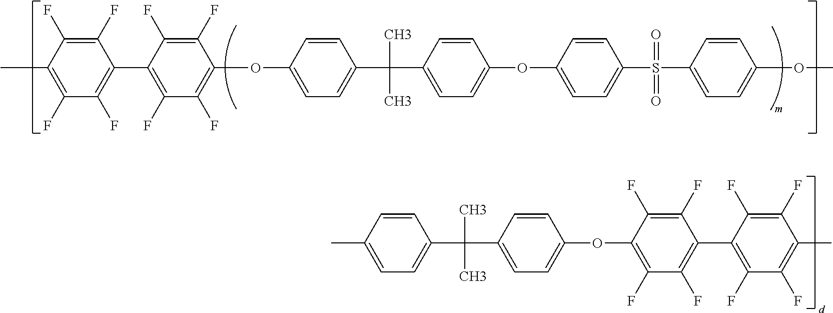
and m is 2-150 and d is 2-150.

6. The ionomer of claim 1, wherein:
R¹ comprises, 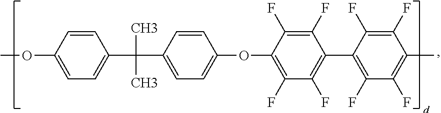
and
d is 2-150.

7. The ionomer of claim 1, wherein:
R² comprises at least one of 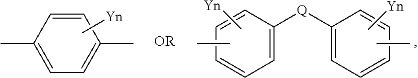
Y is SO₃H, CF₂SO₃H, PO₃H, or N⁺R where R is alkyl or aryl, n is 1-4, and
Q is O, CO, SO₂, C—(CH₃)₂, P(O)R wherein R is alkyl, or C(CX¹X²)_{z}, wherein X¹ and X² are independently selected from H, F, Cl, Br, and I; and, z is 1-20.

8. The ionomer of claim 1, wherein R² comprises: —NH₂, or —SO₂NH₂, or —SO₃H.

9. The ionomer of claim 1, wherein R² comprises phenyl optionally substituted with F, Cl, Br, and I.

10. The ionomer of claim 1, wherein:
R² comprises at least one of —(CX¹X²)_{z}— or —(CX¹X²)zNH—,
X¹ and X² are independently selected from H, F, Cl, Br, and I, and z is 1-20.

11. The ionomer of claim 1, wherein
R² comprises: the fluorinated biphenyl:

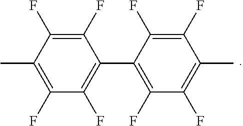

12. The ionomer of claim 1, wherein
R² comprises:

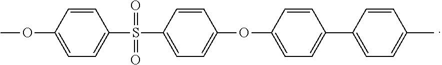

13. The ionomer of claim 1, wherein
R² comprises:

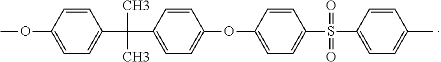

14. The ionomer of claim 1, wherein
R² comprises:

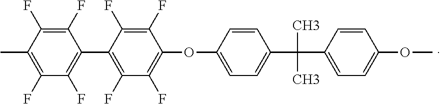

15. The ionomer of claim 1, wherein the polymer backbone comprises the chemical formula: 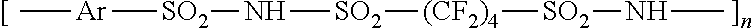
wherein n is 2-100 and wherein Ar is one of: 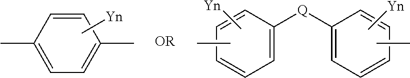
wherein Y is SO₃H, CF₂SO₃H, PO₃H, or N⁺R where R is alkyl or aryl, n is 1-4, and Q is O, CO, SO₂, C—(CH₃)₂, P(O)R wherein R is alkyl, or C(CX¹X²)_{z}, wherein X¹ and X² are independently selected from H, F, Cl, Br, and I; and, z is 1-20.

16. The ionomer of claim 1, wherein the polymer backbone comprises the chemical formula: 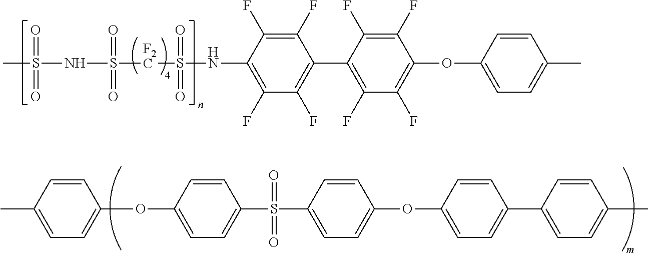
wherein n is 2-100 and m is 2-150.

17. The ionomer of claim 1, wherein the polymer backbone comprises the chemical formula: 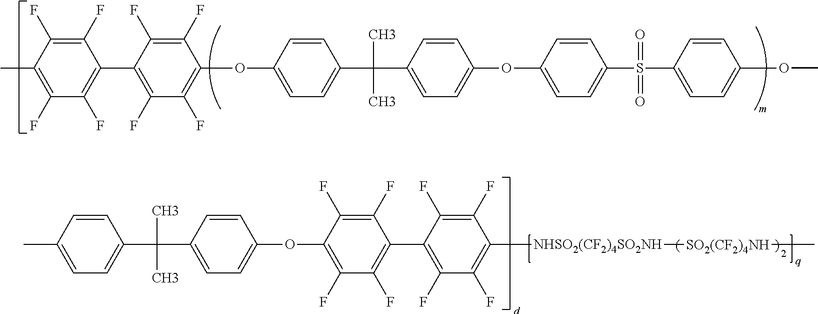
wherein n is 2-100; m is 2-150; d is 2-150; and q is 2-150.

18. The ionomer of claim 1, wherein the polymer backbone comprises the chemical formula: 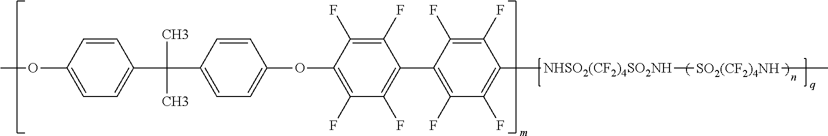
wherein m is 2-150; n is 2-100; and q is 2-150.

19. A bis(sulfonyl)imide ionomer comprising a polymer backbone having the chemical formula: 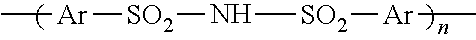
wherein n is 2-100 and wherein each Ar is independently: 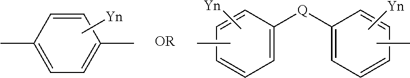
wherein Y is SO₃H, CF₂SO₃H, PO₃H, or N⁺R where R is alkyl or aryl, n is 1-4, and Q is O, CO, SO₂, C—(CH₃)₂, P(O)R wherein R is alkyl, or C(CX¹X²)_{z}, wherein X¹ and X² are independently selected from H, F, Cl, Br, and I; and, z is 1-20.

20. The ionomer of claim 1, wherein the polymer has an ion conductivity of at least 4.8 mS/cm at 70% relative humidity and 60° C.
